(19) United States
(12) Patent Application Publication
(10) Pub. No.: US 2006/0061804 A1
(43) Pub. Date: Mar. 23, 2006

(54) Modular digital photofinishing system

(75) Inventors: Joseph A. Manico, Rochester, NY (US); Frank Marino, Rochester, NY (US); Dana W. Wolcott, Honeoye Falls, NY (US); Jennifer C. Perotti, Pittsford, NY (US); Douglas B. Beaudet, Geneseo, NY (US); Daniel E. Gross, East Bethany, NY (US); Kathleen M. Costello, Rochester, NY (US); John R. Fredlund, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/947,796

(22) Filed: Sep. 23, 2004

(51) Int. Cl. G06F 3/12

(52) U.S. Cl. 358/1.15

(57) ABSTRACT

A system incorporating a handheld image display and manipulation device that is capable of two-way wireless communication or communicating by way of a physical interface with a digital photofinishing system, such as a kiosk, in a retail venue.

### FIELD OF THE INVENTION

The present invention relates to a modular digital imaging assembly that includes a digital photofinishing system, such as a kiosk, and a portable imaging device that are adapted to communicate with each other through a physical docking arrangement between the portable imaging device and the digital photofinishing system or through a wireless interface.

### BACKGROUND OF THE INVENTION

Photo kiosks are well known and accept images from a variety of digital and analog sources including; camera cards, digital image files, Picture CDs, film negatives, un-processed film, prints, video cameras, video tape, images downloaded from the Internet, connected digital cameras, cell phone cameras, etc. It is also known to network kiosks and to provide connection between a kiosk and a further type of digital photofinishing system such as a digital minilab, CD/DVD player/recorder, remote Internet site, alternative format printers, such as a “poster printer”, and lenticular motion card printers. Problems with this situation include, providing a wired infrastructure in a retail venue, user queuing, privacy, and comfort. Many retail establishments have concrete floors, such that providing overhead wiring is unsightly and rewiring an existing store would be costly.

Kiosks also provide a single point of contact limiting access to output devices to one user at a time. In addition, users are usually required to stand in front of the kiosk in order to view and manipulate the images and order image products. Since the kiosk is in an upright configuration in a public location there is no contingency for privacy. In this situation, the personal images of a user may be in open view to any passerby in the retail environment. Users are also required to stand for extended periods of time, cannot engage in other activities while using the kiosk, and may feel pressure to hurry if other users are waiting to use the kiosk.

### SUMMARY OF THE INVENTION

To overcome these limitations what is required is a digital photofinishing assembly that includes a portable or modular digital imaging device that can be provided to users at retail venues. The imaging device can be adapted to communicate either through a wireless interface or a physical interface (such as a docking area that removably holds the imaging device) with a digital photofinishing system such as a stand-alone kiosk. The modular or portable imaging device has a display and a user interface, such as a touch screen, and can be further networked to output, storage, and transmission devices via a docking arrangement with a kiosk or a wireless connection. The device has the ability to read various digital image storage means such as camera cards and Picture CD's directly. It also has the ability to acquire images from other devices such as film scanners, print scanners, cell phone cameras, film processors, online storage such as Ofoto, and local image storage. In the case of online storage, such as Ofoto, it is well known that these services allow users to upload and download image content, make this content available broadly or to select users, and to order image products and services directly from the online storage provider.

Due to the lack of wires for network access and the use of batteries to power the modular imaging device, with the arrangement of the present invention, a user can practice digital imaging tasks and order image output products from anywhere within a retail venue. Retail venues that were once thought of as being incompatible with imaging kiosks and photofinishing due to floor space and aesthetic concerns can be enhanced to include wireless networks and a digital photofinishing infrastructure. The digital photofinishing system could be isolated from the retail environment in a backroom or in an adjacent facility. This would allow users to sit and relax while accessing images with a small portable device without being exposed to the sounds produced by photofinishing equipment or the smells produced by chemical processing agents.

Venues such as bookstores, coffee houses, bars, restaurants, museums, galleries, etc. where users spend leisure and social time would now be ideally suited for sharing images with friends and family. In those retail venues seating is arranged to provide personal spaces. Since the modular imaging device of the present invention could be hand held and/or placed on a table, the user would be afforded a degree of privacy. The portable unit could also be installed in a table or seat back in the case of a large vehicle such as a bus, train, cruise ship, ferry, or airplane. The user would also be relieved of the pressure and discomfort of standing in front of an imaging kiosk while others are waiting for their turns. If the user has his/her images stored on a camera card, he/she would simply insert the card into the modular imaging device to access his/her images. If the image bearing media included prints or unprocessed film that would not be convenient or possible to process on a portable modular hand-held imaging device, the user would give these items to an employee who would perform the appropriate operation in the “backroom” or other alternative location and send the resulting digital images to the imaging device loaned to the user. Order billing can be arranged by the products or services obtained, the time the unit was in use, or a combination of both. In addition loss prevention can be maintained by use of a wireless network to alert the venue staff that the device has left the area intended for use, or has lost contact with the network or by use of a deposit or credit card imprint if the user fails to return the unit or damages it. In addition, loss prevention can be enhanced by enabling the dock to lock the modular hand-held imaging device in place until a valid credit card or ID is provided.

In addition the entire system can be packaged as a portable system suitable for events such as festivals, air shows, sporting events, and the like. The portable hand held imaging devices can be further configured with an image capture element to convert them to wireless digital cameras.

Also, the assembly of the present invention can be configured so that input devices such as film scanners, print scanners, DigiPix rapid film converters, online and local image storage devices, camera card reader/writers, video tape recorder/players, CD/DVD reader/writers, etc. are not directly accessible by the user. This relieves the user of the burden of operating equipment that may be confusing or intimidating. If the input devices were accessible by the user, queues could form if several users required the same input device or multiple devices would be required. Most of these input devices can also serve as output devices enabling the user to view and if desired modify image content such as still images and video segments and re-record to the same or different media via the modular hand-held device.

The system can also create user profiles and preferences if user ID's are provided. This can be used to customize the interface, user experience, image access, image product offerings, and billing such as “frequent user” premiums. It can also be used to collect demographic information to determine buying patterns for promotions, inventory control etc. This ID information can be provided in many forms such as a credit or debit card, biometric data such as a retinal scan or thumb print, or seat assignment information in the case with a vehicle or stadium event.

The present invention therefore relates to a digital imaging assembly that comprises a digital photofinishing system located at a first location and adapted to receive digital images and route the digital images to an output device; and at least one portable digital image receiving and display device. The at least one portable digital image receiving and display device being removably held on a docking area of the digital photofinishing system and being adapted to be physically removed from the docking area to a second location. The at least one portable digital image receiving and display device comprising a digital image insert section to permit an insertion of digital images into the at least one portable digital image receiving and display device, a display to view the inserted images and an interface to order imaging services and provide order information for the inserted images, such that the insertion, viewing, displaying and ordering relative to the digital images inserted into the portable digital image receiving and display device occur at the second location.

The present invention further relates to a method of offering imaging services that comprises the steps of: removably storing at least one portable digital image receiving and display device on a docking area of a digital photofinishing system; permitting a removal of the at least one portable digital image receiving and display device from the docking area to a location remote from said digital photofinishing system; permitting, from the remote location, an ordering session which includes at least a submission of a request for imaging services for customer images loaded into the portable digital image receiving and display device; and transferring the customer images and the request for imaging services from the portable digital image receiving and display device to the photofinishing system.

The present invention further relates to a wireless digital imaging assembly that comprises: a digital photofinishing system located in a retail location and adapted to receive digital data representative of digital images from a plurality of input sources; and a digital image display device located within a predetermined region of the retail location, with the digital image display device having a display for displaying at least one of the digital images and being adapted to communicate with the digital photofinishing system over at least a wireless network. The digital photofinishing system is further adapted to store the digital data and transmit the digital data over the wireless network to the digital image display device; and the digital image display device is adapted to access the digital images solely from the digital photofinishing system and transmit the digital images solely to the digital photofinishing system.

The present invention further relates to a digital imaging assembly which comprises a digital photofinishing system located at a first location and adapted to receive digital images and route the digital images to an output device; and at least one portable digital image receiving and display device, with the at least one portable digital image receiving and display device being removably held on a docking area of the digital photofinishing device and being adapted to be physically removed from the docking area to a second location, and the at least one portable digital image receiving and display device comprising a digital image insert section to permit an insertion of digital images into the at least one portable digital image receiving and display device which is only active when in the docking area. The at least one portable digital image receiving and display device further including a display to view the inserted images and a interface to order imaging services and provide order information for the inserted images. The viewing, displaying and ordering relative to the digital images inserted into the portable digital image receiving and display device occur at the second location.

The present invention further relates to a digital imaging assembly which comprises a digital photofinishing system located at a first location and adapted to receive digital images and route the digital images to an output device; and a stand adapted to removably hold at least one portable digital image receiving and display device thereon, the at least one portable digital image and display device being adapted to be physically removed from the stand to a second location. The at least one portable digital image receiving and display device comprising a digital image insert section to permit an insertion of digital images into the at least one portable digital image receiving and display device, a display to view the inserted images and an interface to order imaging services and provide order information for the inserted images; wherein the insertion, viewing, displaying and ordering relative to the digital images inserted into the portable digital image receiving and display device occur at the second location, and a placement of the portable digital image and display device on the stand enables a communication between the portable digital image and display device and the digital photofinishing system.

### BRIEF DESCRIPTION OF THE DRAWINGS

FIG. 1 is a digital photofinishing assembly that includes a digital photofinishing system and modular imaging devices in accordance with the present invention;

FIG. 2 is a schematic of features of the digital photofinishing system of FIG. 1;

FIG. 3 is a further view of the digital photofinishing assembly of FIG. 1

FIG. 4 is an example of a further embodiment of a communication arrangement between the modular imaging device and the digital photofinishing system of the present invention;

FIG. 5 is a further embodiment of the communication arrangement;

FIG. 6 is a still further embodiment of the communication arrangement.

FIGS. 7A-7C illustrate features of a digital image receiving and display device in accordance with the present invention;

FIGS. 8A-8B are further features of the image receiving and display device in accordance with the invention;

FIG. 9 is a flow chart showing an embodiment with regard to the present invention;

FIG. 10 schematically shows a further feature of the present invention;

FIG. 11 is a flow chart showing a further embodiment with regard to the present invention; and

FIGS. 12A-12B illustrate a further feature of the present invention.

### DETAILED DESCRIPTION OF THE INVENTION

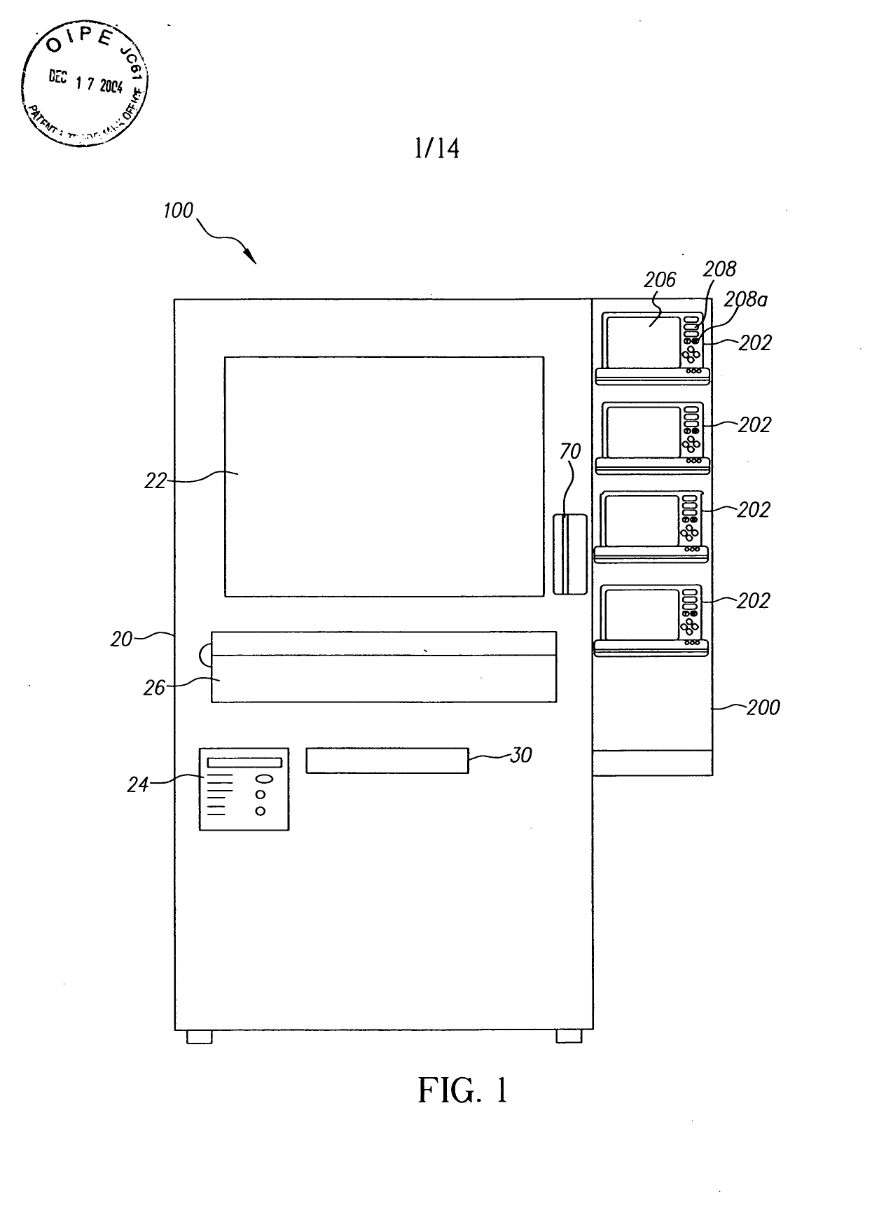

Referring now to the drawings, wherein like reference numerals represent identical or corresponding parts throughout the several views, FIG. 1 shows a first embodiment of a digital photofinishing assembly 100 in accordance with the present invention. Digital photofinishing assembly 100 includes a digital photofinishing system or component 20 configured as, for example, a kiosk. An example of the kiosk is a Picture Maker™ kiosk produced by Eastman Kodak Company. Digital photofinishing system 20 includes a touch screen or display 22 for displaying a digital image and entering instructions; and an input port 24 adapted to receive multiple types of digital storage devices such as a memory card, memory stick, media card, compact flash card, floppy disk, compact disc, PictureCD, or the like as known to those skilled in the art. Input images can also be supplied by way of wireless means such as Bluetooth or infrared, traditional telephone lines or cell phone communications. System 20 can further include a media scanner adapted to scan media such as film or a dock adapted to receive a cell phone and enable the cell phone to transfer images to system 20. While digital photofinishing system has been described as being, for example, a kiosk, system 20 is not limited to a kiosk. It is noted that system 20 could be, for example, a digitally enabled minilab capable of accepting orders from a handheld device.

Digital photofinishing system 20 can optionally include a delivery section 30 controlling the delivery of a medium having the selected image as well as a credit, debit, prepaid or loyalty card payment mechanism 70 that is adapted to permit a user to swipe their card to pay for imaging services.

A digital file comprising a digital image can be transmitted to/from system 20 from/to another display device, a server, digital minilab, wholesale lab, remote computer or other digital device over a communication network.

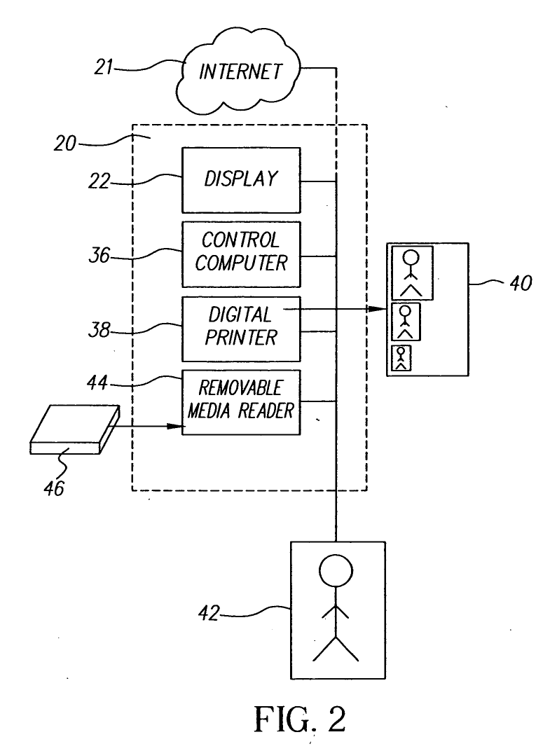

FIG. 2 generally shows a diagram of included functions of digital system 20. As illustrated, digital system 20 can include a computer 36 that typically manages the flow of information and functionality of the elements of digital system 20 in response to input from user 42. Internal to digital system 20 can be a printer 38 for making prints 40, an example of which is the Kodak Digital Science Model 8650 manufactured by Eastman Kodak Company. Printer 38 responds to commands of computer 36 for forming an image on a medium, such as thermal or ink-jet paper. In the case of online storage, such as Ofoto, a user can send and/or receive images via the internet 21. As a further option, a user can send images directly to their home computer via the internet 21 or through wireless means, traditional telephone lines or cell phones. One method of receiving a digital image is illustrated by a removable media reader 44 disposed internal to input port 24 for receiving removable media 46, for example a memory card, floppy disk, compact disc, PictureDC or other form of removable media used in transferring digital files.

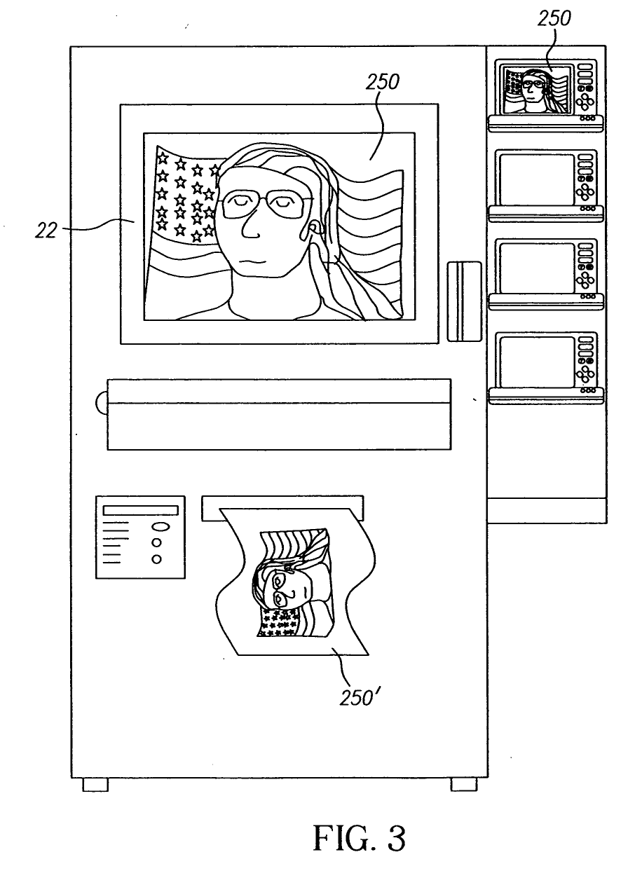

Referring to FIGS. 1 and 3, in a feature of the present invention, digital imaging assembly 100 is made up of digital photofinishing system 20, such as a kiosk as described above, a plurality of portable or modular digital image receiving and display devices 202, and a holding section or docking area 200 adapted to hold modular digital image receiving and display devices 202 for distribution to a user. In the embodiment of FIGS. 1 and 3, holding section or docking area 200 is adapted to removably hold devices 202 on system 20.

With the arrangement of the present invention, assembly 100 is designed and sized to be located at a retail venue such as, for example, a coffee shop. In this case, assembly 100 permits a user to obtain imaging services in the convenience of a private setting such as the booth in which they are sitting. More specifically, in the arrangement as illustrated in FIGS. 1 and 3, multiple image devices 202 can be provided in holding section 200. When a user desires to use assembly 100, the user walks up to assembly 100 and initiates a payment procedure with a credit card, loyalty card, a pre-paid card etc., so as to obtain the release of one of image receiving and display devices 202. Device 202 can then be taken to a second location or a more private location. As shown, devices 202 each include a display window 206 as well as a user interface 208 that permits a user to manipulate images from image storing mediums which are configured to enable a user to use such a device. More specifically, image storage mediums such as camera cards can readily be inserted into an input port of system 20 and images thereon can be transferred to a device 202; or a device 202 can include its own input port 208a which is enabled to permit the insertion of images directly to device 202. Once a user takes a device 202 as disclosed to a private area, the user can thereafter submit images to device 202 as described above or retrieve previously submitted images which can be viewed on display 206. The user can then manipulate the image or images in any manner desired through the use of interface 208. Further, in addition to images, a user can input instructions on how many images to order, instructions on how to manipulate the image, information/instructions regarding the user, and information/instructions on printing to device 202 while the user at is a private location.

After the user completes his/her image ordering session, the user can return device 202 to system 20 and dock or place device 202 on holding section 200. In one embodiment, the physical docking can enable the transfer of images and information/instructions from device 202 to system 20 so as to enable the fulfillment of the imaging order. In the example of FIG. 3, a user has submitted an image 250 shown on display 206 of device 202. Image 250 can optionally be shown on display 22 of system 20 when device 202 is placed in holding section 200. Also, a print 250′ can be printed on system 20.

In one embodiment, system 20 does not transfer images as received from input media to device 202. The images are first modified before being transferred to device 202. An example of such a modification is reducing resolution. The images as received are stored in system 20. After the user inputs information/instructions to device 202, the information/instructions are transferred from device 202 to system 20 so as to enable the fulfillment of the imaging order. In this embodiment, it is unnecessary to transfer images back to system 20 from device 202. Instructions are implemented with images as received and stored on system 20. This may also be the case even if the images are not modified.

In a further embodiment, the insertion of images into device 202 only occurs when device 202 is docked on system 20. In this scenario there are no user accessible image inputs when device 202 is not docked onto system 20. With this embodiment, images are inserted into system 20 via an insert section on system 20 or on device 202 while device 202 is docked to system 20. When image insertion is complete, a user can remove device 202 from the dock and take device 202 to a private setting for an image ordering session. Once complete, device 202 can be returned to system 20 so as to enable the fulfillment of the order.

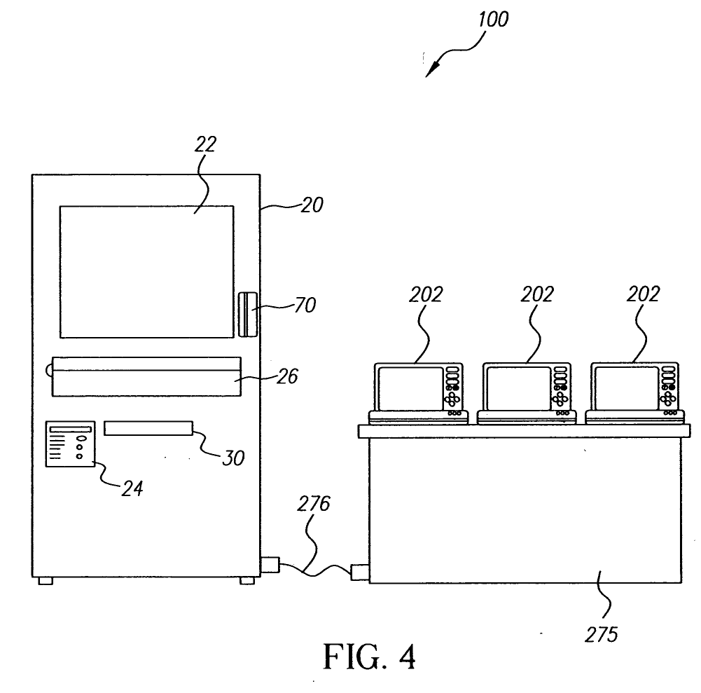

Of course, the present invention is not limited to the physical docking communication orientation shown in FIG. 3, wherein devices 202 are shown attached to system 20 through holding section 200. As a further option, communication between devices 202 and system 20 can be provided in the manner shown in FIG. 4 where devices 202 are optionally provided on an independent or intermediate stand 275 as shown. During an image ordering session, a user can release a device 202 from stand 275 by providing payment information/instructions. When the user has completed his/her image ordering session, the user can dock or place device 202 back onto stand 275 as shown in FIG. 4 to enable the uploading or transfer of images to system 20 via wire 276. This enables a fulfillment of an imaging order in the manner as described above.

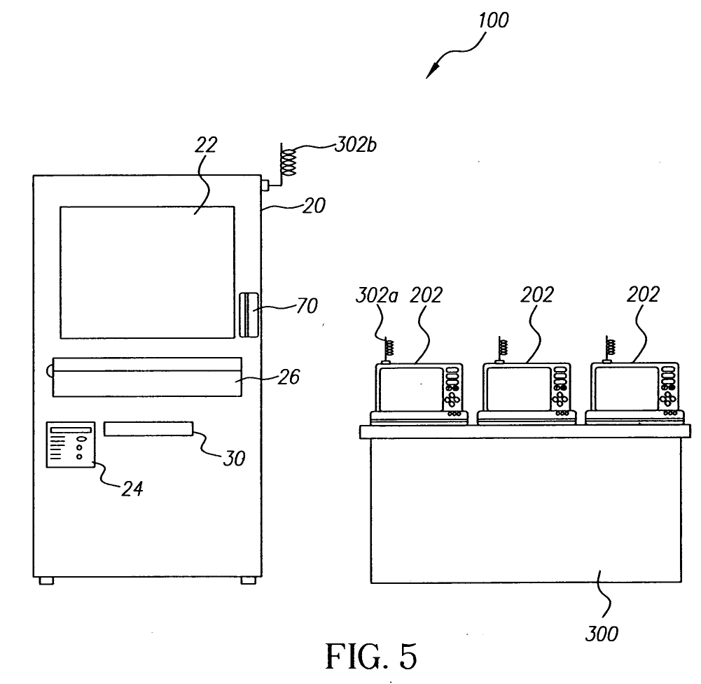

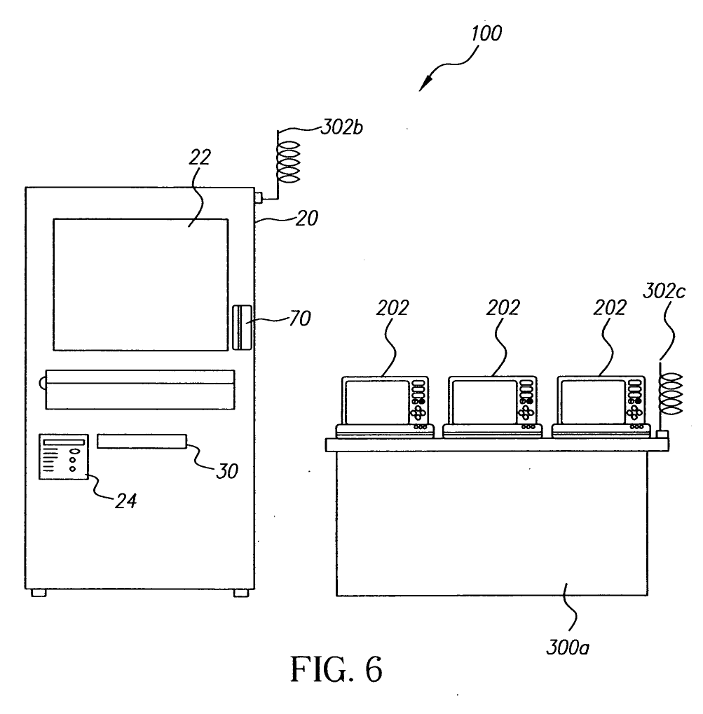

As an option, in the embodiment of FIG. 4 as well as the embodiments of FIGS. 5 and 6 which will be described, stand 275, 300 (FIG. 5) or 300a (FIG. 6) can be provided in the retail venue at a location that is accessible to a user (such as an area next to a counter or on the counter) while system 20 can be located behind the counter and accessible to an operator.

As a further option, as shown in FIG. 5 imaging devices 202 can be provided on a stand 300, and rather than having a hard wire connection between stand 300 and the system 20 as shown in FIG. 3, the connection can be wireless. Therefore, each imaging device 202 would include a wireless antenna 302a which would be enabled to communicate with system 20 through antenna 302 on system 20.

FIG. 6 illustrates an example of a further communication system which can be utilized in the present invention. In the embodiment of FIG. 6, a single antenna 302c is provided on stand 300a. Stand 300a is enabled with a docking configuration and the placement of device 202 on stand 300a will permit a communication of device 202 with system 20 through antennas 302c, 302b.

In addition, loss prevention can be maintained by use of the wireless network to determine when to initiate a notification to alert the venue staff that the device 202 has left the area intended for use, or has lost contact with the network connecting it with system 20. An alarm can sound or other notification means can be used. For example, instead of or in addition to an alarm, the device can be enabled to automatically shut down when the device has left the area of intended use. Also, if the user desires that he/she does not want to order products after using device 202, the system is enabled to erase the memory within device 202 that includes the user's images to ensure that there is no unauthorized use of his/her images.

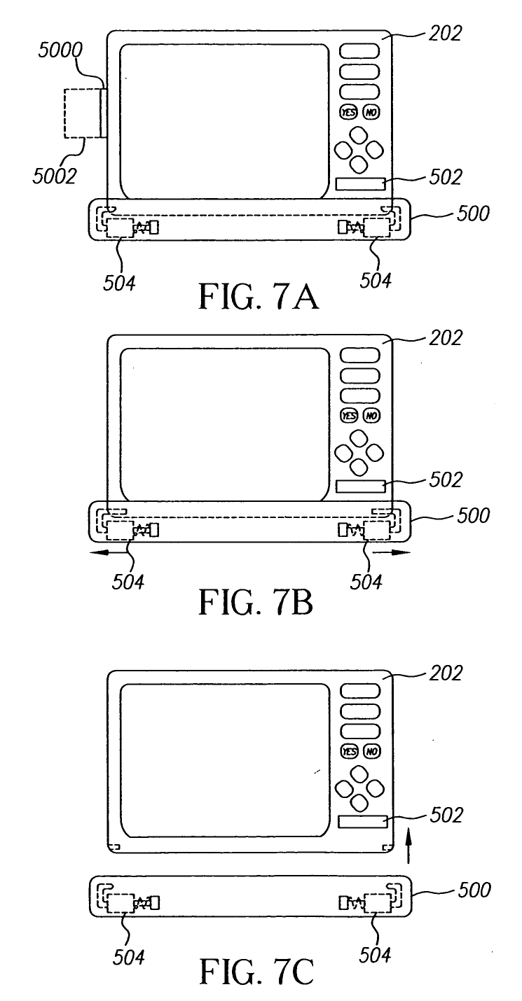

With reference to FIGS. 7A-7C, in an embodiment of the invention, device 202 can be mounted on or provided in a docking or holding area such as 200 as shown in FIG. 1 or stands 275, 300, 300a shown in FIGS. 4-6, that can include a holding member 500. With this arrangement, a user simply has to slide his/her credit card, pre-paid card or loyalty card through the payment mechanism on system 20, stands 275, 300 or 300a, or input port 502 on device 202 to obtain the release of device 202 for an image ordering session. After completion of the image ordering session, in a docking arrangement, the user can place device 202 on holding member 500 which will enable a transfer of images either by way of a wireless connection or a downloading of images directly in the manner discussed above.

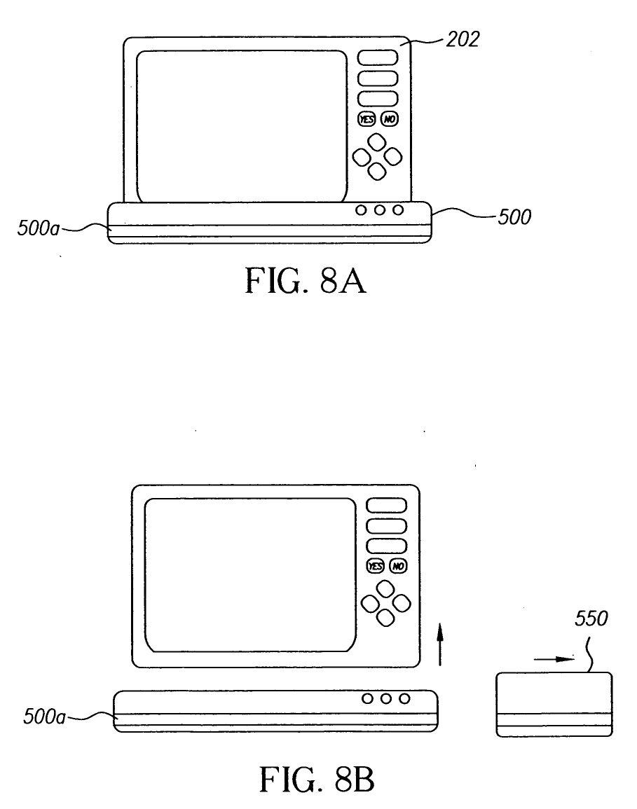

FIGS. 7A-7B show an embodiment for the mechanism for holding member 500. The mechanism can be a solenoid arrangement 504, which is adapted to move from a holding position (FIG. 7A) to a release position (FIG. 7B) after the confirmation of the swiping of a card, or some other type of payment verification. In the release position of holding member 500, device 202 can be removed (FIG. 7C). Therefore, as shown in FIGS. 8A and 8B, in an embodiment of the present invention, a user can swipe a credit card, loyalty card or some other type of prepaid card 550 through a slot 500a provided in holding member 500. Holding member 500 could include a solenoid-type locking arrangement as illustrated in FIGS. 7A-7C, or some other type of known locking arrangement. Upon confirmation that the card has been swiped, and preferably, that it has been approved for providing imaging services, the device 202 can be removed as shown in FIG. 8B and utilized in an image ordering session as previously described.

With device 202 of the present invention, a user can utilize certain types of image bearing mediums that can easily be used with such a modular type unit, such as picture cards. Other types of image bearing mediums, such as film may not be convenient for use with device 202, since a film scanner is required. In that case, the film scanner can be localized on system 20, and thus, the user would enter the images via the scanner at system 20. In this scenario, the user can still practice the present invention, since once the images are downloaded by the scanner, the user can thereafter remove a portable or modular device 202 and manipulate images in privacy at a second location such as at a booth in a coffee shop.

The system of the present invention has been described with reference to a user walking up to a kiosk (for example, system 20), and through the presentation of a loyalty card or some other type of payment mechanism (i.e. credit card), obtaining the release of a device 202 from system 20. Thereafter, the user can take device 202 to a private location where they can proceed with an image ordering/manipulation session as previously described.

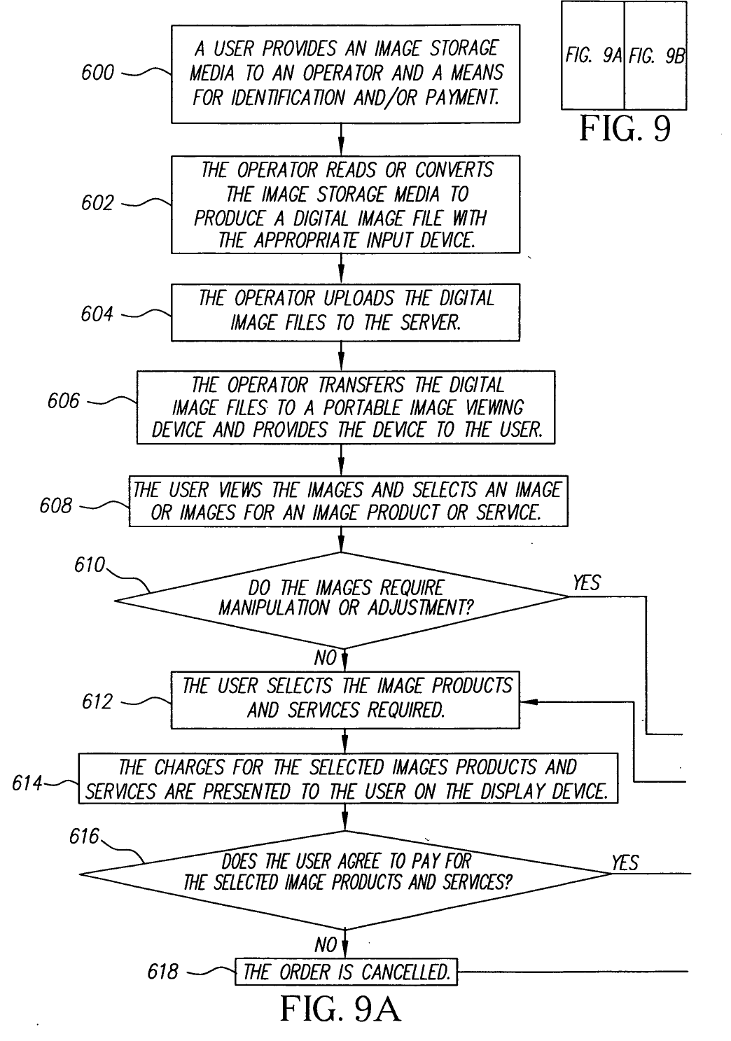

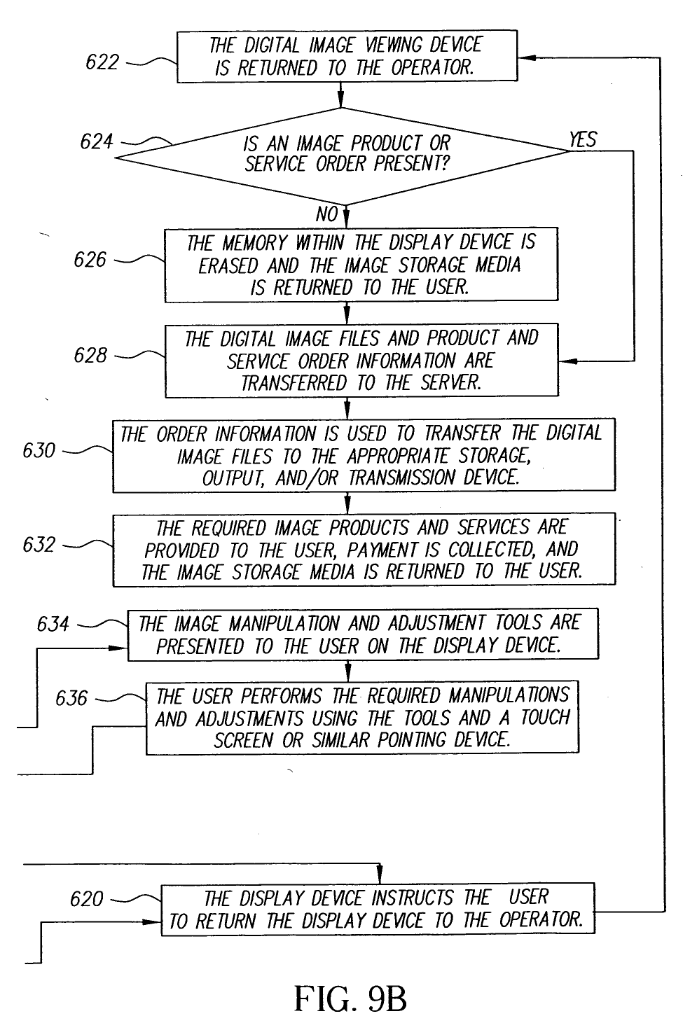

In a further feature of the present invention, rather than approaching system 20 to obtain a release of device 202 and inserting the images into the system themselves, a user can walk up to an operator to submit their image storage medium, and thereafter, the operator can upload the images to a server which are then transferred to device 202. At that point, the user can manipulate the images in a private location through device 202. More specifically, in this embodiment and with reference to the flow chart of FIG. 9, a user provides an image storage media to an operator and a means for identification and/or payment (step 600). The operator can then read or convert the image storage media to produce a digital image file with the appropriate input device (step 602). In step 604, the operator uploads the digital image file to a server, while in step 606, the operator can transfer the digital image files to device 202 and provide the device 202 to the user.

Therefore, unlike the previous embodiment where a user can control the insertion of images, in the embodiment of FIG. 9, the user will initiate the image ordering session by first going to an operator, submitting his/his images, and having the operator provide him/her with a device 202 with the images loaded thereon or with the user having the ability to load the images onto device 202 from a server. The server can be an image server adapted to hold customer image data for future processing. Also, the server could be part of or separate from system 20. In step 608, the user can then view the images and select an image or images for an image product or service. In step 610, it is determined if the images require manipulation or adjustment. If the answer is no, the procedure moves to step 612 where the user can select the image products and/or services required and, thereafter, in step 614, the charges for the selected image products and/or services are presented to the user on the display of the device 202. If the user agrees to pay for the selected image products and/or services, the procedure goes to step 620 where the digital device 202 instructs the user to return the device 202 to the operator. If the answer to step 616 is no, the order is canceled, and the display device 202 instructs the user to return the display device 202 to the operator (step 620).

If the answer to step 610 with respect to inquiring whether the images require manipulation or adjustment is yes, the procedure moves to step 634 where the image manipulation and adjustment tools are presented to the user on the display device 202. Thereafter, the user performs the required manipulations and adjustments using the tools and touch screen or a similar pointing of device on device 202 (steps 636), and the procedure goes back to step 612 where the user can then select the image products and services required. At that point, the process goes to steps 614 and 616 as described above.

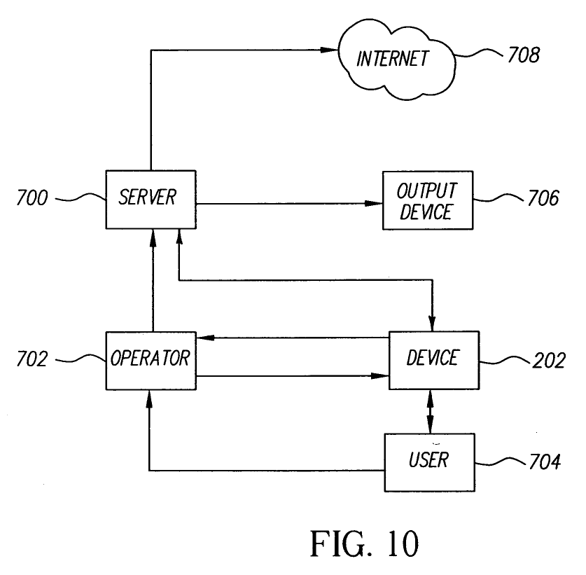

At step 620, the display device instructs the user to return the display device to the operator if the user has agreed to pay for the selected services or if the order is canceled (step 618). At that point, the device 202 is returned to the operator (step 622) and there is an inquiry as to whether an image product or service order is present (step 624). If the answer is no, the memory within display device 202 is erased to ensure that their will be no unauthorized usage of the user's images, and the image storage media is returned to the user (step 626). If the answer is yes, the digital image files and products and service order information are transferred to the server 700 (step 628, FIG. 9; FIG. 10). The order information is then used to transfer the digital image files to an appropriate storage/output device and a transmission device 706, or upload the images to the internet 708 for later retrieval by the user 704 (step 630, FIG. 9; FIG. 10). If the requested service is prints that can be fulfilled onsite, the required image products and services are provided to the user, payment is collected and the image storage media is returned to the user (step 632).

As shown in FIG. 10, with the embodiment of FIG. 9 a user 704 approaches an operator 702 and submits an image storage media as well as a means for payment to operator 702. Operator 702 loads the images on the user's media to a device 202 and provides the user with the device 202 for an image ordering session. The user 704 then utilizes device 202 during an image ordering session, and after the session completed, the device 202 is returned to the operator 702. As a further option, during the presentation of the image storage media to the operator, the operator 702 can upload the digital image files to server 700 which can be accessed through a wireless communication by a user having device 202 during an image ordering session. After the image ordering session is complete, user 704 returns the device 202 to operator 702. The digital image files and the products or service ordered can then be provided to an appropriate output device 706 or uploaded to the internet 708.

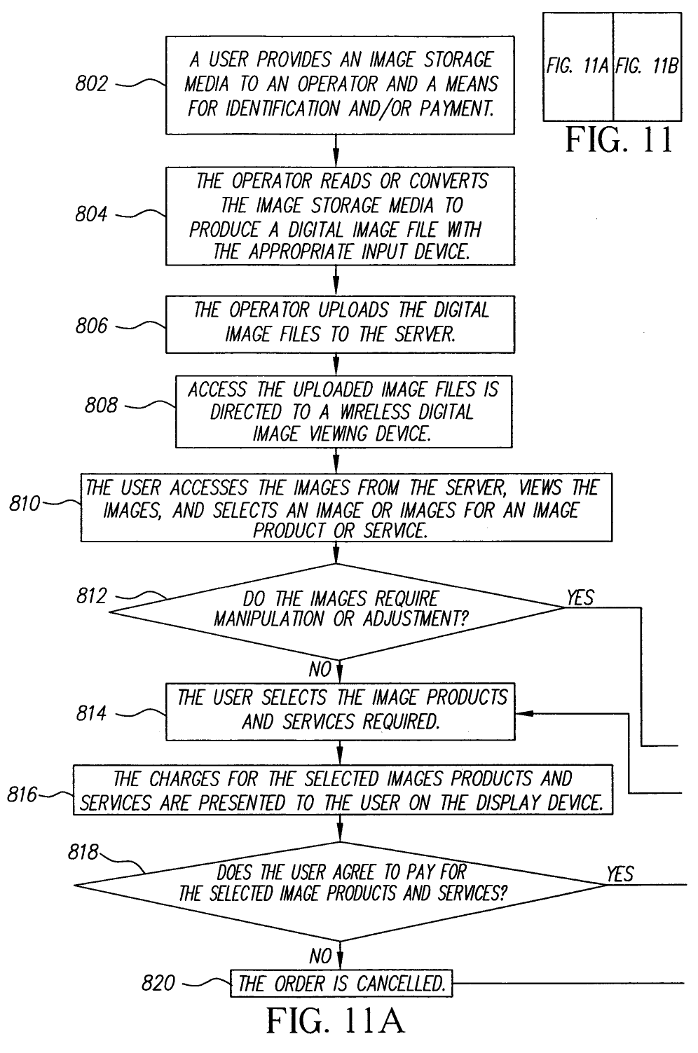

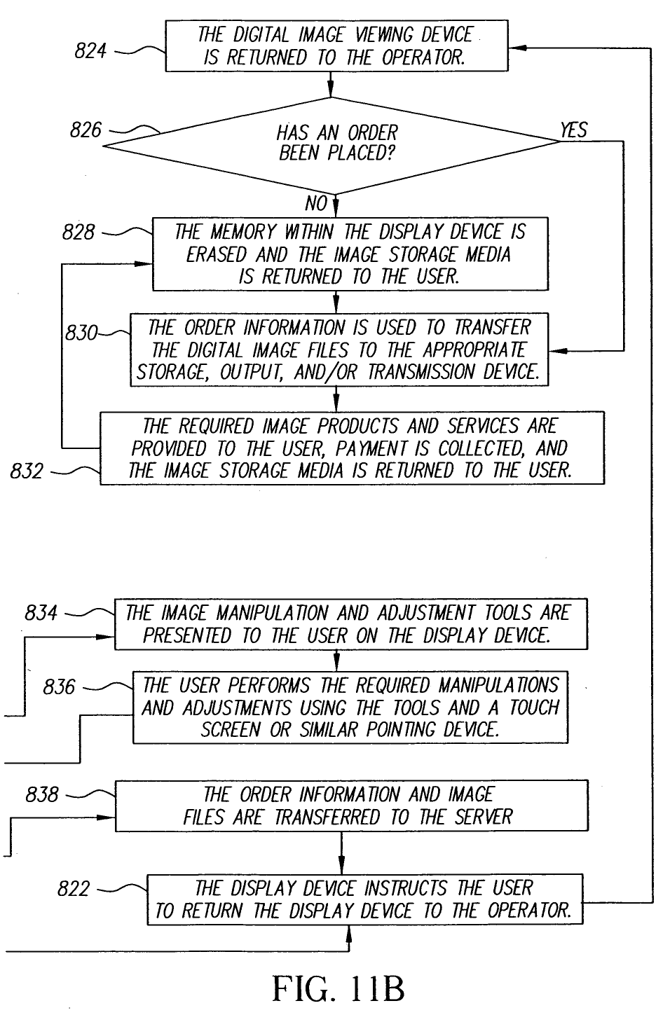

FIG. 11 illustrates an embodiment based on a wireless communication as noted above. In the flow chart of FIG. 11, the workflow would work in the following manner. In step 802, a user provides an image storage media to an operator, as well as a means for identification and/or payment as in the previous embodiment of FIGS. 9 and 10. Thereafter, the operator reads or converts the image storage medium to produce a digital image file with the appropriate input device (step 804). The operator uploads the digital image files to the server (step 806), and, access to the uploaded image files is directed to a wireless digital image-viewing device such as device 202 (step 808). The user accesses the images from the server, views the images and selects an image or images for an image product or service (step 810). At step 812, it is inquired as to whether the images require manipulation or adjustment. If the answer is yes, image manipulation and adjustment tools are presented to the user on device 202 (step 814), and the user performs the required manipulations and adjustments using the tools in a touch screen or similar pointing device (step 816). Thereafter, at step 814 the user selects the image products and services required. If the answer to step 812 is no, the procedure goes directly to step 814 where the user selects the image products and services required. At step 816, the charges for the selected image products and services are presented to the user on display device 202, and at step 818, the question is presented whether the user agrees to pay for the selected image product and services. If the answer to step 818 is no, the order is canceled (step 820). If the answer is yes, the order information and files are transferred to the server (step 838).

Thereafter, display device 202 instructs the user to return the display device to the operator (step 822). It is further noted that if the answer is no to step 818, and the order is canceled (step 820), the procedure goes to step 822, where the display device instructs the user to return the display device to the operator (step 822). After step 822, the device 202 is returned to the operator (step 824), and then there is a check to see whether an order has been placed (step 826). If the answer is no, the memory within display device 202 is erased to assure that no unauthorized use of the images occur, and the image storage media is returned to the user (step 828). If the answer is yes, the procedure goes on to step 830 where the order information is used to transfer the digital image files to the appropriate storage, output and/or transmission device. Thereafter, the required image products and services are provided to the user, payment is collected and the image storage media is returned to the user (step 832). At this point, the procedure can go to step 828 where the memory within the display device 202 is erased and the image storage media is returned to the user.

As described, the arrangement and method of the present invention is applicable in a retail environment or location such as a department store, a restaurant or a coffee shop. Other types of retail environments or locations to which the arrangement and method of the present invention is applicable would be on a cruise ship, an amusement park, a national park, a zoo etc., or an airline arrangement that includes at least the departure airport, the destination airport and the airplane.

On a cruise ship, park, zoo etc., the kiosk (digital photofinishing system) can be placed at the park, zoo or ship, and the device 202 can be distributed to the customer for use while in the park, zoo or on the ship in a manner analogous to the description provided above with regard to a retail establishment. In this way, a user can continuously obtain photofinishing services and print and/or upload images while they are at the park, zoo etc or on the ship.

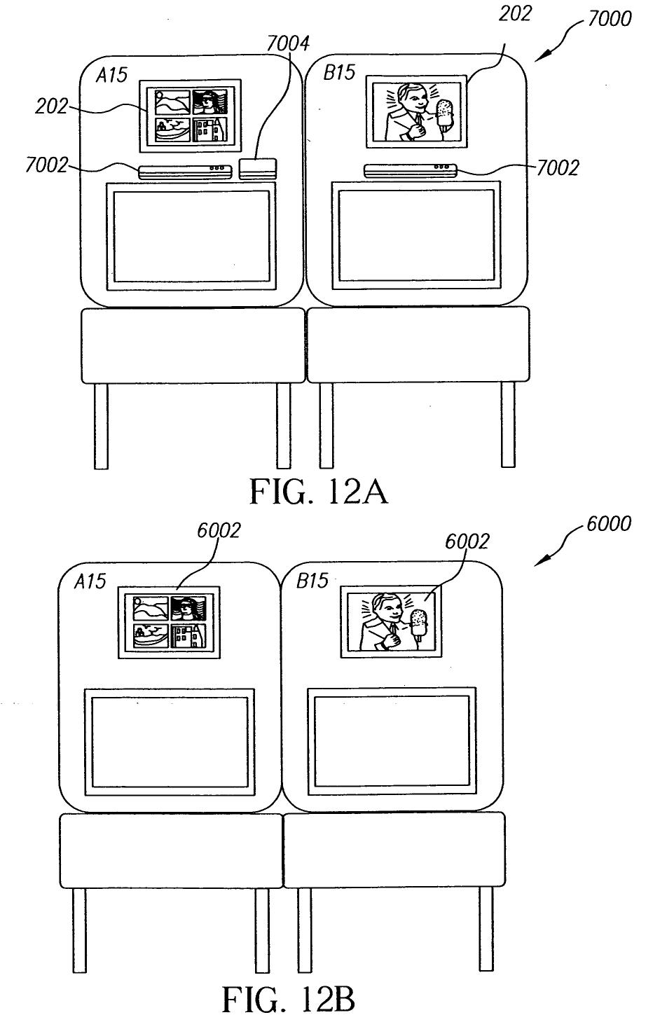

In an airport environment, a kiosk can be provided at a departure airport where a user can access the kiosk and/or upload images to the service. Thereafter, while on the plane a user can use the device 202 in a manner as described above, wherein seats 7000 include an interface locking member 7002 that permits a customer to unlock and use device 202 with a payment card 7004 as shown in FIG. 12A. As a further embodiment, seats 6000 can have an existing display 6002 and a touch screen for use by the customer as shown in FIG. 12B. The service would provide for the wireless transfer of the customer's images to the plane based on the customer's ticket and/or the seat location for the customer known from the ticket. On the other hand, the customer can be provided with an identification number such as a user access number that permits the customer to go to a website while on the plane and access the images that have been wirelessly transferred to the plane.

As a still further embodiment, in the case where the user is traveling and submits his/her image file at the departure site such as an airport, a bus depot, a seaport or train station, the service provider at the departure site can be enabled to transfer the images to an intermediary device such as a camera card or disk with the transferred images thereon such as a DVD or CD. Thereafter, the service provider can provide the user with the card or disk with the transferred images thereon at the departure site, can arrange for the physical delivery of the card or disk to an enabled system on board the mode of transportation, or can deliver the card disk or directly to the user either before they arrive at the mode of transportation or while they are on the mode of transportation. In this embodiment, the user's seating location or some other designation on the mode of transportation would include a device 202 that would be enabled to read the images from the card or disk, and would permit the user to perform an image ordering session as described above. The user's images in accordance with the image ordering session can be fulfilled on the mode of transportation or at a remote location such as the final destination of the user. The user may also designate to have the final output sent to their home or any other location designated by the user.

In a further feature of the invention, the device 202 can include an interface 5000 (FIG. 7A) that permits a camera or an image capture device 5002 to be attached and/or locked thereto. The use of the image capture device or camera can be based on the same security and payment criteria as the use of the device 202. This permits a customer to also use device 202 as an image capture device or camera while on a cruise ship or at an amusement park, zoo etc. In this case, if the device is used in an area that includes picture taking opportunities, a user can utilize camera enabled device 202 to take pictures and conduct an image ordering session similar to the process described above with regard to images loaded onto device 202. The interface 5000 can also be enabled to permit a transfer of images from the camera 5000 to the device 5002.

In a still further feature of the invention, the digital photofinishing system of the present invention can be enabled to accept and create video images to permit a customer to create, edit and view video images while using the system.

In a still further feature of the invention, the system of the present invention can be enabled to generate enticement coupons on the device 202 which could be general in nature or could have a connection to the retail environment, cruise ship, park or zoo where the customer is using the device. In this manner, the customer can receive enticements on the display while using the device 202, or can receive enticements with their prints.

It is further noted that with respect to inputting digital images and/or outputting digital images with regard to the disclosed embodiments, such images can be transferred via wireless means, traditional telephone lines or cell phones.

Further, in the case of multiple users sending images simultaneously to system 20, queuing of the images can be established by a first-in-first-out process (FIFO), a frequent user priority, output size requirements or any other level of priority established by the provider.

Also, for rapid access to images, the system of the present invention can be adapted to provide low-resolution versions of the user's images to enable a quick review and/or preview of the images.

The invention has been described in detail with particular reference to certain preferred embodiments there, but it will be understood that variations and modifications can be affected within the spirit and scope of the invention.

1. A digital imaging assembly comprising:
a digital photofinishing system located at a first location and adapted to receive digital images and route the digital images to an output device; and
at least one portable digital image receiving and display device, said at least one portable digital image receiving and display device being removably held on a docking area of said digital photofinishing device and being adapted to be physically removed from said docking area to a second location, said at least one portable digital image receiving and display device comprising a digital image insert section to permit an insertion of digital images into said at least one portable digital image receiving and display device, a display to view the inserted images and a interface to order imaging services and provide order information for the inserted images, wherein the insertion, viewing, displaying and ordering relative to the digital images inserted into said portable digital image receiving and display device occur at said second location.

2. A digital imaging assembly according to claim 1, further comprising a wireless communication interface between said at least one portable digital image receiving and display device and said digital photofinishing system to permit a wireless transfer of said inserted images and said order information from said at least one portable digital image receiving and display device at said second location to said digital photofinishing system.

3. A digital imaging assembly according to claim 2, wherein said digital photofinishing system is adapted to route the transferred images to an output device in accordance with the order information.

4. A digital imaging assembly according to claim 1, wherein said portable digital image receiving and display device is adapted to transfer of said inserted images and said order information from said at least one portable digital image receiving and display device to said digital photofinishing system when said portable digital image receiving and display device is placed on said docking area.

5. A digital imaging assembly according to claim 4, wherein said digital photofinishing system is adapted to route the transferred images to an output device in accordance with the order information.

6. A digital imaging assembly according to claim 1, wherein said first location is within a retail venue and said digital photofinishing system is a stand-alone kiosk

7. A digital imaging assembly according to claim 6, wherein said second location is within a predetermined region of the retail venue remote from said first location.

8. A digital imaging assembly according to claim 1, wherein said digital photofinishing system is adapted to removably hold a plurality of said portable digital image receiving and display components.

9. A digital imaging assembly according to claim 1, further comprising a locking mechanism adapted to retain said portable digital image receiving and display device locked until a predetermined condition is met.

10. A digital imaging assembly according to claim 1, further comprising use of a wireless network to determine when to initiate a notification to indicate that said portable digital image receiving and display device has left the area intended for use, or has lost contact with the wireless network.

11. A digital imaging assembly according to claim 1, further comprising transferring modified images to said portable digital image receiving and display device.

12. A digital imaging assembly according to claim 1, wherein said portable digital image receiving and display device is adapted to erase a user's image when imaging services are not requested.

13. A digital imaging assembly according to claim 1, wherein said first and second locations are located on a cruise ship, within a park or within a zoo.

14. A digital imaging system according to claim 1, wherein said portable digital image receiving and display device includes a camera interface.

15. A device according to claim 1, wherein said images comprise video images.

16. A method of offering imaging services, the method comprising the steps of:
removably storing at least one portable digital image receiving and display device on a docking area of a photofinishing system;
permitting a removal of the at least one portable digital image receiving and display device from said docking area to a location remote from said photofinishing system;
permitting, from said remote location, an ordering session which includes at least a submission of a request for imaging services for customer images loaded into said portable digital image receiving and display device; and
transferring said customer images and said request for imaging services from said portable digital image receiving and display device to said photofinishing system.

17. A method according to claim 16, wherein said transferring step comprises wirelessly transferring said customer images and said request for imaging services from said portable digital image receiving and display device to said photofinishing system.

18. A method according to claim 16, wherein said transferring step comprises placing the portable digital image receiving and display device on said docking area of said photofinishing system to enable a transfer of said customer images and said request for imaging services.

19. A method according to claim 16, comprising the further step of routing said transferred customer images from said photofinishing system to an output device.

20. A method according to claim 16, wherein said photofinishing system is a stand-alone kiosk located in a retail venue and said remote location is a location within a predetermined area of said retail venue.

21. A method according to claim 16, further comprising the step of retaining said portable digital image receiving and display device in a locked state until a predetermined condition is met.

22. A method according to claim 16, further comprising the step of using a wireless network to determine when to initiate a notification to indicate that said portable digital image receiving and display device has left the area intended for use, or has lost contact with the wireless network.

23. A method according to claim 16, further comprising transferring modified images to said portable digital image receiving and display device.

24. A method according to claim 16, further comprising transferring no images from said portable digital image receiving and display device to said system.

25. A method according to claim 16, comprising the further step of generating enticements based on the use of said portable digital device.

26. A wireless digital imaging system comprising:
a digital photofinishing system located in a retail location and adapted to receive digital data representative of digital images from a plurality of input sources; and
a digital display device located within a predetermined region of the retail location, said digital display device having a display for displaying at least one of the digital images and being adapted to communicate with said digital photofinishing system over at least a wireless network;
wherein:
said digital photofinishing system is further adapted to store the digital data and transmit the digital data over said wireless network to said digital display device; and
said digital display device is adapted to access the digital images solely from the digital photofinishing system and transmit the digital images solely to the digital photofinishing system.

27. A system according to claim 26, wherein said digital display device further comprises:
a user interface that is configured to permit a user to select the at least one digital image displayed on said display, manipulate the at least one selected image, and place an order comprising the at least one selected image.

28. A digital imaging assembly according to claim 26, further comprising a locking mechanism adapted to retain said portable digital image receiving and display device in a locked state until a predetermined condition is met.

29. A digital imaging assembly according to claim 26, further comprising use of a wireless network to determine when to initiate a notification to indicate that said portable digital image receiving and display device has left the area intended for use, or has lost contact with the wireless network.

30. A digital imaging assembly according to claim 26, further comprising transferring modified images to said portable digital image receiving and display device.

31. A digital imaging assembly according to claim 26, further comprising transferring no images from said portable digital image receiving and display device to said system.

32. An assembly according to claim 25, wherein said retail location comprises an airport and said digital display device is associated with a seat on an airplane.

33. A digital imaging assembly comprising:
a digital photofinishing system located at a first location and adapted to receive digital images and route the digital images to an output device; and
at least one portable digital image receiving and display device, said at least one portable digital image receiving and display device being removably held on a docking area of said digital photofinishing device and being adapted to be physically removed from said docking area to a second location, said at least one portable digital image receiving and display device comprising a digital image insert section to permit an insertion of digital images into said at least one portable digital image receiving and display device which is only active when in said docking area, a display to view the inserted images and a interface to order imaging services and provide order information for the inserted images, wherein viewing, displaying and ordering relative to the digital images inserted into said portable digital image receiving and display device occur at said second location.

34. A digital imaging assembly according to claim 33, further comprising a locking mechanism adapted to retain said portable digital image receiving and display device in a locked state locked until a predetermined condition is met.

35. A digital imaging assembly according to claim 33, further comprising use of a wireless network to determine when to initiate a notification to indicate that said portable digital image receiving and display device has left the area intended for use, or has lost contact with the wireless network.

36. A digital imaging assembly according to claim 33, further comprising transferring modified images to said portable digital image receiving and display device.

37. A digital imaging assembly according to claim 33, further comprising transferring no images from said portable digital image receiving and display device to said system.

38. A digital imaging assembly comprising:
a digital photofinishing system located at a first location and adapted to receive digital images and route the digital images to an output device; and
a stand adapted to removably hold at least one portable digital image receiving and display device thereon, said at least one portable digital image and display device being adapted to be physically removed from said stand to a second location, said at least one portable digital image receiving and display device comprising a digital image insert section to permit an insertion of digital images into said at least one portable digital image receiving and display device, a display to view the inserted images and an interface to order imaging services and provide order information for the inserted images, wherein the insertion, viewing, displaying and ordering relative to the digital images inserted into said portable digital image receiving and display device occur at said second location, and a placement of said portable digital image and display device on said stand enables a communication between said portable digital image and display device and said digital photofinishing system.

39. A digital imaging assembly according to claim 38, wherein said communication between said at least one portable digital image receiving and display device on said stand and said digital photofinishing system is a wireless communication of said inserted images and said order information from said at least one portable digital image receiving and display device on said stand to said digital photofinishing system.

40. A digital imaging assembly according to claim 38, wherein said communication between said portable digital image receiving and display device on said stand and said digital photofinishing system is through a wired connection.
